(19) United States
(12) Patent Application Publication
(10) Pub. No.: US 2017/0286963 A1
(43) Pub. Date: Oct. 5, 2017

(54) METHODS FOR PLACING A PRECONDITION OVER COLLATERAL

(71) Applicant: MasterCard Asia/Pacific Pte. Ltd., Singapore (SG)

(72) Inventor: Rajen Srinivasa Prabhu, Singapore (SG)

(21) Appl. No.: 15/474,068

(22) Filed: Mar. 30, 2017

(30) Foreign Application Priority Data
Apr. 4, 2016 (SG) 10201602653U

(51) Int. Cl. G06Q 20/40; G06Q 20/10

(52) U.S. Cl. CPC G06Q 20/4037; G06Q 20/10

(57) ABSTRACT

Described are methods for placing a precondition over collateral. Such methods include the steps of receiving, at a first point in time, initiation details of a transfer initiated by an initiator, the initiation details comprising a payment vehicle reference, transfer identifier and a transfer value, and sending the payment vehicle reference, transfer identifier and transfer value to a transfer network. Afterward, one transfer securement server is determined, from a plurality of transfer securement servers each administered by a transfer securement administrator, based on the payment vehicle reference, the one transfer securement server being associated with the payment vehicle reference.

### CROSS-REFERENCE TO RELATED APPLICATION

This application is a U.S. National Stage filing under 35 U.S.C. §119, based on and claiming benefit of and priority to SG Patent Application No. 10201602653U filed Apr. 4, 2016.

### TECHNICAL FIELD

The present disclosure relates to methods for enabling a third party to place a precondition over collateral while enabling an owner of the collateral to benefit from its retention at least until the precondition is resolved.

### BACKGROUND

Consumer and banking regulations, particularly in some countries such as India, are tightening. On the one hand, this has made it increasingly difficult for consumers to access credit facilities since financial regulation of credit is onerous. On the other hand, debit facility providers are finding it less profitable to offer debit facilities as debit interchange and merchant discount rates are capped at ever decreasing amounts.

It would be advantageous therefore to provider a method for resolving one or more of the above difficulties with credit and debit facilities, or at least to provide a useful alternative.

### SUMMARY

In accordance with the present disclosure there is provided a method for placing a precondition over collateral, the method comprising:
receiving, at a first point in time, initiation details of a transfer initiated by an initiator, the initiation details comprising a payment vehicle reference, transfer identifier and a transfer value;
sending the payment vehicle reference, transfer identifier and transfer value to a transfer network;
determining, based on the payment vehicle reference, one transfer securement server from a plurality of transfer securement servers each administered by a transfer securement administrator, the one transfer securement server being associated with the payment vehicle reference;
sending the payment vehicle reference, transfer identifier and transfer value to the one transfer securement server,
wherein one of the transfer network and the one transfer securement server is in communication with an account database comprising a first user account associated with the initiator, the first user account comprising an account balance,
determining, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; and
at a second point in time later than the first point in time, satisfying the precondition by transferring the collateral to the transfer securement administrator of the one transfer securement server.

In accordance with the present disclosure there is also provided a method for placing a precondition over collateral, the method comprising:
receiving, at a first point in time, initiation details of a transfer initiated by an initiator, the initiation details comprising a payment vehicle reference, transfer identifier and a transfer value;
sending the payment vehicle reference, transfer identifier and transfer value to a transfer network;
determining, based on the payment vehicle reference, one transfer securement server from a plurality of transfer securement servers each administered by a transfer securement administrator, the one transfer securement server being associated with the payment vehicle reference;
sending the payment vehicle reference, transfer identifier and transfer value to the one transfer securement server, wherein one of the transfer network and the one transfer securement server is in communication with an account database comprising a first user account associated with the initiator, the first user account comprising an account balance, determining, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value;
at a second point in time later than the first point in time, receiving from the initiator a transfer amount equivalent to the portion of the account balance; and removing the precondition from the collateral.

The present disclosure also provides a system for placing a precondition over collateral, comprising a computer, the computer comprising:
at least one processor; and
at least one memory including computer program code;
the at least one memory and the computer program code configured to, with at least one processor, cause the computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; and at a second point in time later than the first point in time, satisfy the precondition by transferring the collateral to the transfer securement administrator of the one transfer securement server.

The present disclosure still further provides a system for placing a precondition over collateral, comprising a computer, the computer comprising:
at least one processor; and
at least one memory including computer program code;
the at least one memory and the computer program code configured to, with at least one processor, cause the computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; at a second point in time later than the first point in time, receiving from the initiator a transfer amount equivalent to the portion of the account balance; and remove the precondition from the collateral.

The present disclosure further provides a computer readable medium including computer program code for placing a precondition over collateral, the code being configured to, with at least one processor, cause a computer at least to: receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; and
at a second point in time later than the first point in time, satisfy the precondition by transferring the collateral to the transfer securement administrator of the one transfer securement server.

The present disclosure also provides a computer readable medium including computer program code for placing a precondition over collateral, the code being configured to, with at least one processor, cause a computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value;
at a second point in time later than the first point in time, receiving from the initiator a transfer amount equivalent to the portion of the account balance; and remove the precondition from the collateral.

Unless context dictates otherwise, the following terms will be given the meanings provided here:
“associated” as it refers to a payment vehicle reference being associated with a transfer securement administrator, means that the payment vehicle is issued by the transfer securement administrator;
“associated” as it refers to an initiator being associated with a user account, refers to an account containing collateral (e.g. currency or funds) the initiator is authorised to use as consideration in a transfer;
“increase amount” refers to any one of a plurality of different types of benefits received by an initiator for an account balance, such as interest on funds in the user account and a bonus for having a minimum monthly account balance;
“initiation details”, when used in relation to a transfer, refer to details of the transfer such as, but not limited to, the payment vehicle reference, transfer identifier and transfer value. The initiation details may also comprise additional details such as a date (and time) of the transfer, a geographical location of the transfer, or a merchant identifier that identifies a particular store, chain of stores, franchise;
“initiator” is a consumer that initiates a transfer;
“payment vehicle” may refer to any form of financial vehicle through which payment may be made including, but not limited to, a credit card, a debit card and a user bank account;
“payment vehicle reference” refers to a unique identifier of the payment vehicle;
“precondition” refers to a security interest over collateral in the user account, such as a lien preventing a portion of the account balance of the account from being used while the lien remains in place;
“remaining credit limit” refers to the difference between a credit limit of a credit facility and the funds that remain available in that credit facility (i.e. the credit facility minus the outstanding balance of that facility).
“satisfy” in terms of an account balance or funds being sufficient to satisfy a transfer value, collateral or transaction amount, means that the account balance, collateral or funds are at least equal in value to the transfer value or transaction amount; and
“transfer” refers to the transfer of consideration from one party to another in a transaction. Such consideration may be, for example, an amount of a particular currency;
“transfer identifier” refers to a reference for the particular transfer by which that transfer can be identified. For example, when a credit card transaction occurs, a transfer identifier is allocated to the transaction so that the settlement funds can be paid to the appropriate merchant and associated with the relevant transaction being settled;
“transfer network” refers to a payment scheme, or similar, that communicates between an issuer bank and an acquirer bank;
“transfer securement administrator” refers to a provider of credit or debit facilities, such as an issuer bank in the case of credit facilities, or an issuer bank or acquirer bank in the case of debit facilities;
“transfer securement server” refers to a computer server administered by a transfer securement administrator for the purpose of providing credit and/or debit facilities;
“transfer value” comprises an amount of consideration given, or promised, to affect the transfer;

Some embodiments of the invention may enable a transfer securement administrator to provide credit facilities with security over funds held in a user account.

Some embodiments of the invention may enable an initiator to avail themselves of services akin to debit services, while maintaining the benefit of the funds for transfers being in their account for a period after the transfer—for example, for the accumulation of interest.

### BRIEF DESCRIPTION OF THE DRAWINGS

Some embodiments will not be described by way of non-limiting example only, with reference to the accompanying drawings in which:

FIG. 1 illustrates a method for placing a precondition over collateral;

FIG. 2 illustrates an alternative method for placing a precondition over collateral;

FIG. 3 is a schematic representation of a credit card network;

FIG. 4 is a schematic representation of a debit card network;

FIG. 5 is a schematic representation of a network for carrying out the methods of FIGS. 1 and 2;

FIG. 6 is an expanded block diagram of an exemplary embodiment of a server architecture of a computer system for placing a precondition over collateral; and

FIG. 7 illustrates an exemplary configuration of a server system shown in FIG. 6.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

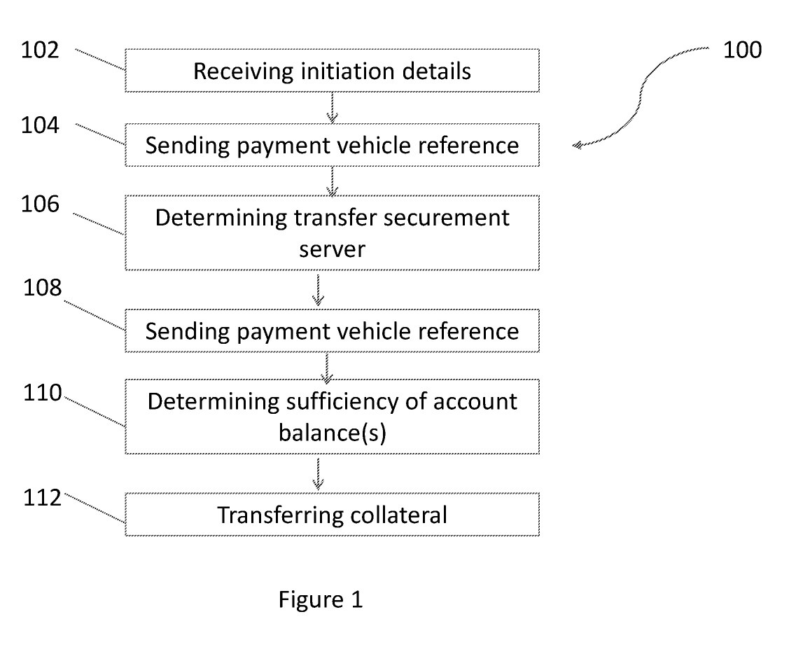

FIG. 1 provides a method 100 for placing a precondition over collateral.

The method 100 broadly comprises the steps of:
Step 102: receiving initiation details;
Step 104: sending payment vehicle reference to transfer network;
Step 106: determining the appropriate transfer securement server from one of many transfer securement servers;
Step 108: sending payment vehicle reference to transfer securement server;
Step 110: determining sufficiency of account balance(s); and
Step 112: transferring collateral.

Step 102 involves receiving initiation details. The initiation details may be received upon commencement of a financial transaction, such as a purchase transaction. The purchase transaction may be initiated using any means and thus the initiation details may be received through, for example, a point-of-sale terminal, credit or debit card terminal, internet payment gateway or internet portal.

The initiation details comprise at least those details necessary to effect settlement of the transfer. In this sense, ‘settlement’ comprises the transfer of funds from an initiator of the transfer to the merchant or supplier of that which is acquired by the initiator.

The details necessary to effect settlement will typically comprise at least a payment vehicle reference, a transfer identifier and a transfer value.

The payment vehicle reference enables the payment vehicle, with which the transaction was initiated, to be identified. For example, the payment vehicle reference may be a credit card number, a debit card number, a bank account number, a token representative of any of those numbers or other unique reference by which the relevant payment vehicle is identifiable.

The transfer identifier comprises a unique reference by which the particular transfer is identifiable. The transfer identifier enables the settlement funds to be delivered to the appropriate merchant, and may also provide a mechanism for uniquely identifying the transfer in future. For example, the transfer identifier may be used as a receipt number.

The transfer value is the consideration offered by the initiator of the transaction. Typically, the transfer value will typically comprise monetary consideration in the form of funds or currency. The transfer value is the price paid by the initiator for whatever the initiator is acquiring in the transfer.

The initiation details may also comprise additional information such as:
a merchant identifier that uniquely identifies the merchant or group of merchants (e.g. a chain of stores or a franchise);
a transfer date/time on which the transfer took place;
transfer location, enabling the particular location of the transfer to be known, which can be significant where multiple merchants use a common merchant identifier (e.g. a chain of stores);
transfer basket, being the list of products and services acquired in the transfer; and other details as necessary.

Step 104 comprises sending the initiation details to a transfer network. The transfer network communicates between an acquirer bank, with whom the merchant has a relationship, and an issuer bank, that provides any credit required to fulfil the transfer. Thus the initiation details may be forwarded from an acquirer bank to the transfer network. Similarly, the initiation details may be forwarded from a merchant to the merchant's acquirer bank for onward forwarding to the transfer network.

A transfer network may comprise an entity such as a payment scheme (e.g. MasterCard®).

The transfer network then determines which transfer securement administrator (or appropriate transfer securement server), or issuer bank, issued the payment vehicle to the initiator—per step 106. This can be done using any relevant means, such as identifying a transfer securement administrator from a credit card number. This enables the transfer network to appropriately route the initiation details to the transfer securement administrator's server in order to link the transaction with the funds for settlement of the transaction.

Once the transfer securement server has been identified the initiation details are sent to that server, per step 108, for processing of the transfer. In a traditional credit card transaction pre-allocated third party funds are used for settlement, or the transfer is refused where there are insufficient available funds. In a traditional debit card transaction funds in the initiator's account are used for settlement, or the transfer is refused where there are insufficient available funds. In the present method, a user account of the initiator is analysed to determine whether that account contains a balance sufficient to fulfil the transfer—step 110. For example, where the user account comprises a bank account, the bank account will be queried to determine whether it contains sufficient money to settle the transfer. If the account contains a balance sufficient to affect the transfer, then credit funds (e.g. third party funds) are used to effect settlement despite there being a sufficient balance in the user account to effect settlement.

Instead of removing part of the balance, or debiting funds, from the user account a precondition is placed over collateral in the user account. The collateral comprises a portion of the account balance that is, at most, equal to the transfer value. The precondition limits the usage of the collateral for the period the precondition remains in place. For example, where the precondition comprises a security interest, such as a lien, over funds in a user's bank account the user may not be able to access those funds. However, this does not prevent the funds from accumulating interest in the normal course of remaining in the user's bank account. Thus, while third party credit may be used to fund a particular transfer even where the user has sufficient funds to settle that transfer, the user has the benefit of those funds for the period of time until settlement with the transfer securement administrator takes place at which time the precondition is resolved.

Settlement with the transfer administrator may comprise transferral of the collateral as set out in step 112. In this embodiment, the collateral is debited from the initiator's user account at a point in time that is later than the time at which the transfer was initiated. While it is understood that a transfer can be initiated and settlement is then effected by deducting from the user account, this deduction occurs a matters of seconds after initiation of the transfer. In the present methods, however, it is intended that ‘later’ refers to an appreciable period of time—for example, a day, multiple days, weeks and so forth.

Thus the initiator can, in effect, avail themselves of a periodic credit facility (e.g. a 45 or 55 day credit term) while having that credit secured and thereby enabling the transfer securement administrator to avoid risk and reduce regulatory requirements of the provision of the pseudo-credit facility. Similarly, the initiator is, in effect, using their own funds to affect the transfer but is handing over those funds at a point in time later than the point in time at which the transfer took place.

Notably, where the balance of the user account is less than the transfer value, the transfer may be refused. Alternatively, one or more further user accounts may then be consulted to determine whether the total balance of the first mentioned user account plus the balance of any further user accounts is greater than or equal to the transfer value. If so, then the transfer takes place and a precondition is applied over collateral in multiple accounts, that collateral being at most equal to the transfer value. If the total balance of all user accounts is less than the transfer value then the transfer may be refused. Alternatively, if the total balance of all user accounts is less than the transfer value by an amount that is acceptable to a regulatory authority, then the transfer may still take place. For example, where the total account balance is less than the transfer value by an amount that the regulatory authority would have permitted to be issued to the initiator as the credit limit of a credit facility, then the transfer may take place. Thus the transfer would, in effect, involve some pure credit funds and some secured credit funds, along with a precondition over the total account balance of all user accounts or, alternatively, over an amount of the account balance that is equal to the transfer value minus the amount that a regulatory authority would permit to be issued to the initiator as a credit limit of a credit facility.

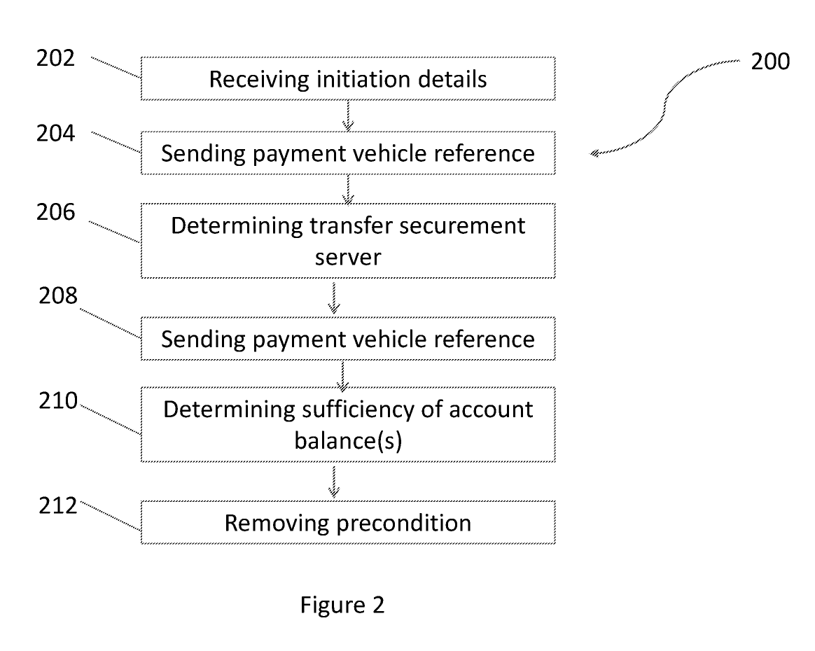

FIG. 2 provides a method 200 for placing a precondition over collateral. The method 100 broadly comprises the steps of:

Step 202: receiving initiation details;

Step 204: sending payment vehicle reference to transfer network;

Step 206: determining the appropriate transfer securement server from one of many transfer securement servers;

Step 208: sending payment vehicle reference to transfer securement server;

Step 210: determining sufficiency of account balance(s); and

Step 212: removing precondition.

Steps 202 to 210 are substantially the same as steps 102 to 110 and will thus not be discussed in detail.

The difference between the method of FIG. 1 and that of FIG. 2 is that FIG. 1 resolves the precondition (i.e. removes it) by debiting the collateral from the user account. In contrast, FIG. 2 permits the user to resolve the precondition using alternative collateral. For example, the user may elect to pay the transfer value to the transfer securement administrator in advance of that collateral being debiting from the user account. Thus, there is no longer a reason to retain the precondition in place, and it is thus removed per step 212. This may occur where, for example, the user has a precondition over so much of their existing account balance that they are unable to perform additional transfers. The user may then provide alternative collateral (e.g. a payment from a bank account linked with a financial institution other than the transfer securement administrator) so as to have one or more preconditions over existing collateral to be removed. Thus the initiator's payment vehicle will again be capable of effecting transfers

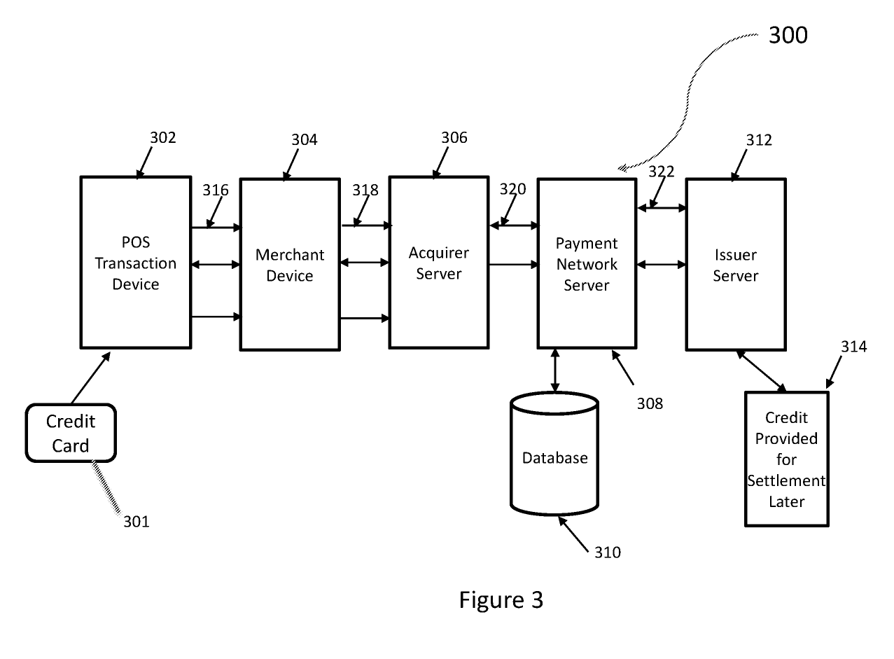

FIG. 3 provides a schematic flowchart 300 of a standard, in-store credit card usage procedure. In this procedure a consumer (not shown) selects one or more products and services to purchase. The consumer presents their credit card 301, to a point-of-sale (POS) transaction device 302 that takes details or credentials (e.g. credit card number and expiry date) for payment for the product(s) or service(s). Where the procedure is used in an on-line context, it will be appreciated that the credit card details may be inputted into a payment gateway or payment portal to effect payment.

The POS device 302 sends a signal 316 comprising the credit card credentials and transaction details to a merchant device or merchant server 304. The merchant device or server 304 then sends a signal 318 comprising the credit card credentials and transaction details to an acquirer server 306—for example, the server of a bank or other financial institution. The acquirer server 306 again forwards the credit card credentials and transaction details in a transmission 320 to a payment network server 308 of a payment network, such as a payment scheme. The payment network server 308 then consults a database 310 of issuers to determine the appropriate issuer to whom to send the credit card credentials and transaction details. Once determined, the credit card credentials and transaction details are sent in a transmission 322 to the issuer server 312 of the appropriate issuer.

The issuer server 312 determines whether a credit facility 314 includes sufficient funds to settle the transaction. If there is insufficient credit the transaction is rejected. If there is sufficient credit the transaction is approved, the funds for settlement are debited from the credit facility, the issuer takes a fee from the debited funds and passes the remaining funds to the payment network server 308. The payment network server 308 debits a fee from the funds and passes the remaining funds to the acquirer server 306. The acquirer server 306 also takes a fee from the debited funds and transfers the remaining funds to the merchant server or directly into the merchant's bank account held by the acquirer.

This process requires a consumer to have been approved for a credit facility, often to pay an annual fee for usage of that facility, and to have sufficient funds available to pay the balance of the credit facility at an appropriate later point in time after any transactions have taken place. If the consumer has insufficient funds to pay the balance of the credit facility, they instead typically pay a very high interest rate until the balance of the credit facility has been paid. In addition, even if the consumer has the funds to pay the balance of the credit facility, if they do not remember to do so or are otherwise unable to do so by the appropriate date (e.g. if travelling overseas or out of internet reception) then they will be charged the high interest rate on the outstanding amount of the credit facility.

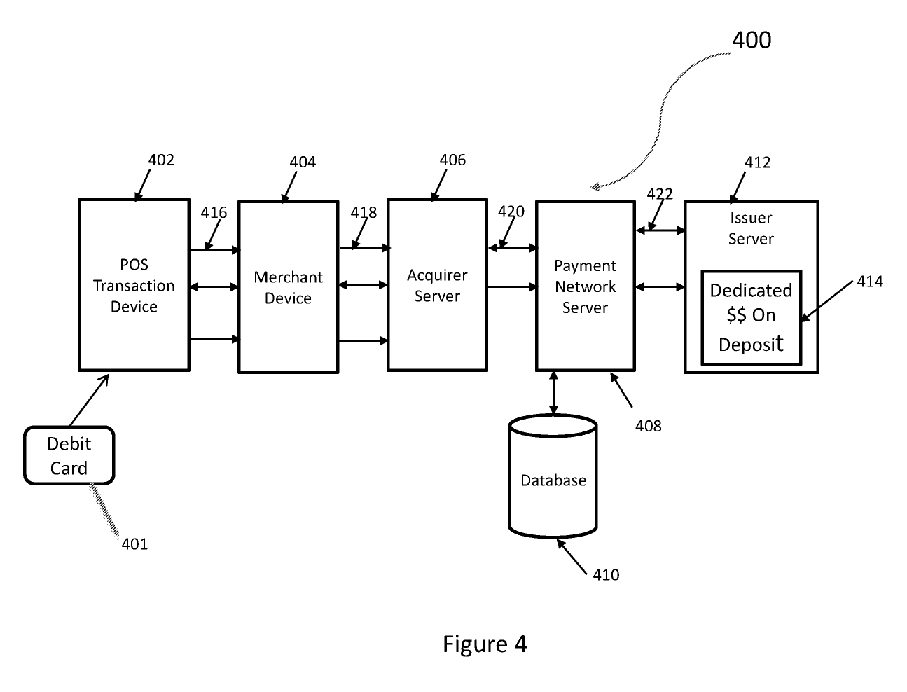

FIG. 4 provides a schematic flowchart 400 of a standard, in-store debit card usage procedure. In this procedure a consumer (not shown) selects one or more products and services to purchase. The consumer presents their debit card 401, to a point-of-sale (POS) transaction device 402 that takes details or credentials (e.g. debit card number and expiry date) for payment for the product(s) or service(s). Where the procedure is used in an on-line context, it will be appreciated that the debit card details may be inputted into a payment gateway or payment portal to effect payment.

The POS device 402 sends a signal 416 comprising the debit card credentials and transaction details to a merchant device or merchant server 404. The merchant device or server 404 then sends a signal 418 comprising the debit card credentials and transaction details to an acquirer server 406—for example, the server of a bank or other financial institution. The acquirer server 406 again forwards the debit card credentials and transaction details in a transmission 420 to a payment network server 408 of a payment network, such as a payment scheme. The payment network server 408 then consults a database 410 of issuers to determine the appropriate issuer to whom to send the debit card credentials and transaction details. Once determined, the debit card credentials and transaction details are sent in a transmission 422 to the issuer server 412 of the appropriate issuer.

The issuer server 412 has access to a deposit account 414 associated with the consumer and determines whether the deposit account 414 contains sufficient funds to settle the transaction. If there are insufficient funds the transaction is rejected. If there are sufficient funds the transaction is approved, the funds for settlement are debited from the deposit account, the issuer takes a fee from the debited funds and passes the remaining funds to the payment network server 408. The payment network server 408 debits a fee from the funds and passes the remaining funds to the acquirer server 406. The acquirer server 406 also takes a fee from the debited funds and transfers the remaining funds to the merchant server or directly into the merchant's bank account held by the acquirer.

This process requires a consumer to have funds in their account to effect a transaction and, once a transaction is made, the consumer is immediately deprived of the benefit of those funds. In other words, the funds do not accrue interest or otherwise accumulate any form of increase (e.g. bonus for minimum monthly account balance).

Thus, a consumer with a credit facility having an interest-free period (e.g. 45 days or 55 days), and with sufficient funds in a deposit account to pay the balance of that credit facility, may use the credit facility for the interest-free period while gaining the advantage (e.g. interest accrual) of their deposit account funds. Contrastingly, a person with sufficient funds in their deposit account but who is not approved for a credit facility neither has the advantage of such a credit facility to make purchases for which the consumer can later render themselves accountable to pay, nor do they have the full benefit of the funds in their deposit account if they are to use a debit card to pay for transactions, since funds are immediately debited from their account upon making the transaction.

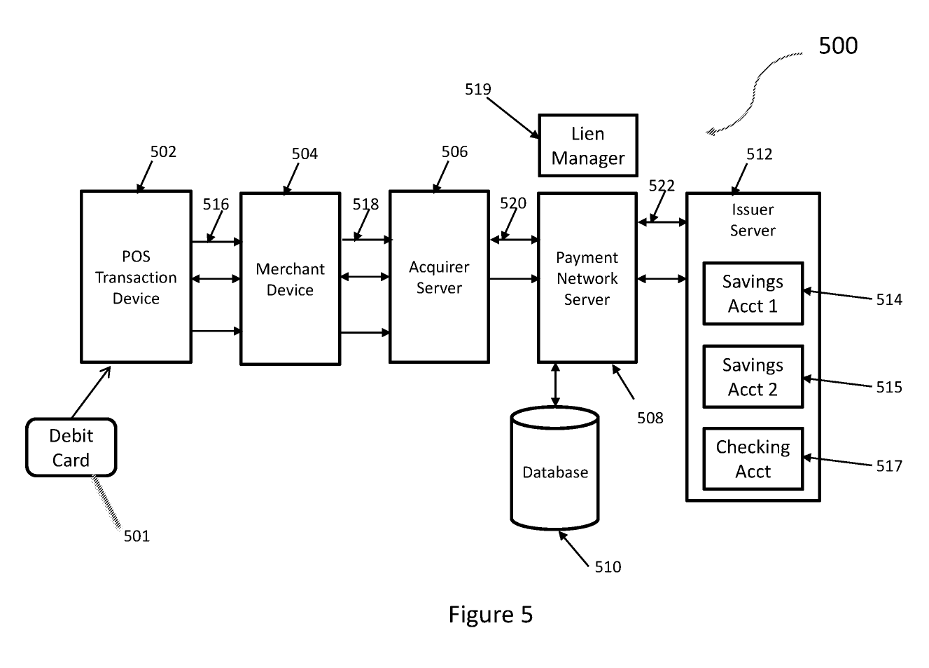

FIG. 5 provides a schematic flowchart 500 of a procedure performed over a network implementing the methods of FIGS. 1 and 2. In this procedure an initiator (not shown) selects one or more products and services to purchase. The initiator presents their payment vehicle, presently a debit card 501, to a point-of-sale (POS) transaction device 502 that takes details or credentials (e.g. debit card number and expiry date) for payment for the product(s) or service(s). Where the procedure is used in an on-line context, it will be appreciated that the debit card details may be inputted into a payment gateway or payment portal to effect payment.

The POS device 502 sends a signal 516 comprising initiation details (e.g. the debit card details, transaction amount, transaction date and merchant identifier) to a merchant device or merchant server 504. The merchant device or server 504 then sends a signal 518 comprising the initiation details to an acquirer server 506—for example, the server of a bank or other financial institution. The acquirer server 506 again forwards the initiation details in a transmission 520 to a transfer network server 508 of a transfer network, such as a payment scheme. The transfer network server then consults a database 510 of transfer securement administrators to determine the appropriate administrator to whom to send the initiation details. Once determined, the initiation details are sent in a transmission 522 to the transfer securement server, or issuer server 512, of the appropriate transfer securement administrator.

Since the initiator is using a debit card 501 the typical course of action would be that the issuer server 512 would immediately debit funds from a user account (e.g. account 514) of the user. In the present instance, however, no such immediate debiting occurs. One or more user accounts 514, 515, 517 are accessible to the transfer securement server 512—in other embodiments, the user accounts 514, 515, 517 may be accessible to the acquirer server 506 or payment network server 508. The user accounts 514, 515, 517 each contain an account balance which may be, for example, a balance of funds for use in transactions.

Upon receipt of the initiation details, the transfer securement server 512 (or other server as the case may be) communicates to a precondition manager, presently lien manager 519, that a transfer has been initiated. Either the issuer server 512 or lien manager 519 then determines whether there is a sufficient account balance to cover the transfer value (e.g. the cost of the purchase initiated by the initiator). If the account balance is sufficient to cover the transfer value the lien manager 519 places a precondition, or lien, over collateral in the account. Presently, the collateral comprises a portion of the funds or balance of the account that is at most equal to the transfer value. The collateral is not debited from the user account. Thus the collateral secures the transfer without depriving the initiator of the benefit of their funds for a period of time—for example, a period of time equal to an interest-free period that would otherwise be offered of a credit facility.

Where the account balance of a first account—for example, account 514—is insufficient to cover the transfer, the transfer securement server 512 or lien manager 519 may identify one or more other user accounts associated with the initiator and containing an account balance over which a precondition is able to be placed (either over part of the account balance or the full account balance). If such a user account is present, the lien manager may place a lien over collateral in that account. If no such single user account contains an account balance sufficient to cover the transfer value, but a combination or sum of account balances is sufficient for that purpose, then the lien manager may place a precondition over collateral comprising a portion (whether it be the whole, or less than the whole) of the account balance in two or more user accounts.

Where the initiator is eligible for a credit facility, but the limit of that facility (or the remaining limit of that facility) is insufficient to cover the transfer value, the remaining funds in the credit facility may be used and the difference between the remaining funds and the transfer value may then constitute an amount of collateral, in the balance of one or more user accounts, over which a precondition is placed by the lien manager.

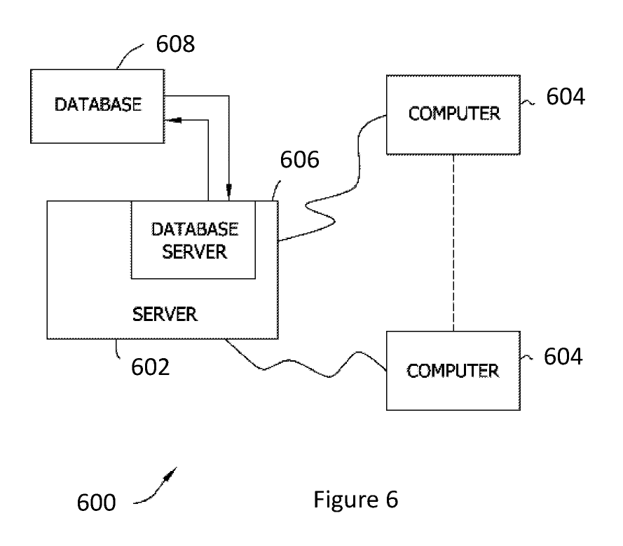

FIG. 6 is a simplified block diagram of an exemplary network-based system 600 used for placing a precondition over collateral. System 600 is a client/server system that may be utilized for storage and delivery of data. More specifically, in the example embodiment, system 600 includes a server system 602, and at least one client computer system. Presently the system 600 includes a plurality of client sub-systems, also referred to as client computer systems 604, connected to server system 602. In one embodiment, client systems 604 are computers including a web browser, such that server system 602 is accessible to client systems 604 using the Internet. Client systems 604 may be interconnected to the Internet through a variety of interfaces including a network, such as a local area network (LAN) or a wide area network (WAN), dial-in-connections, cable modems and special high-speed ISDN lines. Client systems 604 could be any device capable of interconnecting to the Internet including a personal computer (PC), a web-based phone, personal digital assistant (PDA), or other web-based connectable equipment.

A database server 606 is connected to database 608, which contains information on one or more of: user accounts associated with various initiators; references that can be deduced from payment vehicle credentials and can be used to identify appropriate transfer securement administrators; account balances of user accounts: and so forth. In one embodiment, centralized database 608 is stored on server system 602 and can be accessed by potential users (e.g. merchants, acquirers, transfer networks, issuers) at one of client systems 604 by logging onto server system 602 through one of client systems 604. In an alternative embodiment, database 608 is stored remotely from server system 602 and may be non-centralized. Database 608 may store electronic files. Electronic files may include electronic documents, web pages, image files and/or electronic data of any format suitable for storage in database 608 and delivery using system 600.

The system 600 may actually be involved in collection of data for determining how to handle liens over an initiator's account balance(s). For example, the system 600 may be involved in the provision of financial services over a network and thereby collect data relating to merchants, account holders or customers, developers, issuers, acquirers, purchases made, and services provided by system 600 and systems and third parties with which the system 600 interacts. For example, server system 602 could be in communication with an interchange network.

Similarly, database 608 may also store account data including at least one of a cardholder name, a cardholder address, an account number, and other account identifier. Database 608 may also store merchant data including a merchant identifier that identifies each merchant registered to use the network, and instructions for settling transactions including merchant bank account information. Database 608 may also store purchase data associated with items being purchased by a cardholder from a merchant, and authorization request data.

The database 608 may also be a non-transitory computer readable medium storing or embodying a computer program for placing a precondition over collateral. The program may include at least one code segment executable by a computer to instruct the computer to perform a method as described herein, for example with reference to FIGS. 1 and 2.

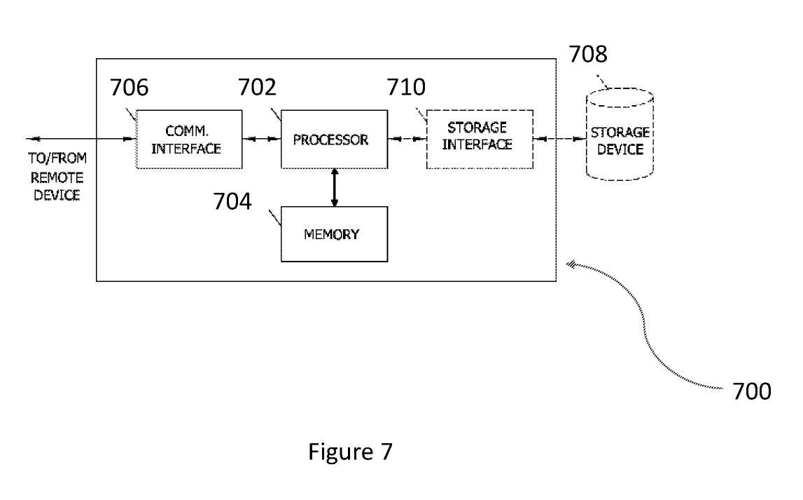

FIG. 7 illustrates an exemplary configuration of a computing device 700, similar to server system 600 (shown in FIG. 6). Computing device 700 may include, but is not limited to, database server, application server, web server, fax server, directory server, and mail server.

Server computing device 700 also includes a processor 702 for executing instructions. Instructions may be stored, for example, in a memory area 704 or other computer-readable media. Processor 702 may include one or more processing units (e.g., in a multi-core configuration).

Processor 702 may be operatively coupled to a communication interface 706 such that server computing device 700 is capable of communicating with a remote device such as user computing device 704 (shown in FIG. 7) or another server computing device 700. For example, communication interface 706 may receive requests from client system 704 via the Internet.

Processor 702 may also be operatively coupled to storage device 708. Storage device 708 is any computer-operated hardware suitable for storing and/or retrieving data. In some embodiments, storage device 708 is integrated in server computing device 700. For example, server computing device 708 may include one or more hard disk drives as storage device 708. In other embodiments, storage device 708 is external to server computing device 700 and may be accessed by a plurality of server computing devices 700. For example, storage device 708 may include multiple storage units such as hard disks or solid state disks in a redundant array of inexpensive disks (RAID) configuration. Storage device 708 may include a storage 2area network (SAN) and/or a network attached storage (NAS) system.

In some embodiments, processor 700 is operatively coupled to storage device 708 via a storage interface 710. Storage interface 710 is any component capable of providing processor 702 with access to storage device 708. Storage interface 710 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 702 with access to storage device 708.

In operation, the processor 702, coupled to a memory device (including memory device 704 and storage device 708), is configured to perform a method for placing a precondition over collateral. In particular, the processor is configured to receive, at a first point in time, initiation details of a transfer initiated by an initiator, the initiation details comprising a payment vehicle reference, transfer identifier and a transfer value, and thereafter send the payment vehicle reference, transfer identifier and transfer value to a transfer network. The processor, or the transfer network, is then configured to determine, based on the payment vehicle reference, one transfer securement server from a plurality of transfer securement servers each administered by a transfer securement administrator, the one transfer securement server being associated with the payment vehicle reference, and that determination is made, send the payment vehicle reference, transfer identifier and transfer value to the one transfer securement server. The processor is further configured to determine, at the one of the transfer network and the one transfer securement server, based on the transfer value, whether the account balance of a first user account is sufficient to satisfy the transfer value and, if so, allocating a precondition to collateral comprising a portion of the account balance, the portion being equal to at most the transfer value. The processor is then configured either to (a) receive a transfer amount, at a second point in time later than the first point in time, from the initiator, the transfer amount being equivalent to the portion of the account balance, and thereafter remove the precondition over the collateral, or (b) at a second point in time later than the first point in time, satisfy the precondition by transferring the collateral to the transfer securement administrator of the one transfer securement server.

The computer system 700 may be instructed by a computer program embodied on a non-transitory computer readable medium, such as memory device 704 or storage device 708. The program stored on the device 704 708 would include at least one code segment, and most likely many thousands of code segments, executable by a computer to instruct the computer to perform the requested operations. Similarly, the program may be stored remotely. To this end, the computer system may constitute a client computer system of a network-based system for placing a precondition over collateral.

Many modifications and variations of the present teachings will be apparent to the skilled person in light of the present disclosure. All such modifications and variations are intended to fall within the scope of the present disclosure. Moreover, to the extent possible, features form one of the embodiments described herein may be used in one or more other embodiments to enhance or replace a feature of the one or more other embodiments. All such usage, substitution and replacement is intended to fall within the scope of the present disclosure.

1. A method for placing a precondition over collateral, the method comprising:
receiving, at a first point in time, initiation details of a transfer initiated by an initiator, the initiation details comprising a payment vehicle reference, transfer identifier and a transfer value;
sending the payment vehicle reference, transfer identifier and transfer value to a transfer network;
determining, based on the payment vehicle reference, one transfer securement server from a plurality of transfer securement servers each administered by a transfer securement administrator, the one transfer securement server being associated with the payment vehicle reference;
sending the payment vehicle reference, transfer identifier and transfer value to the one transfer securement server,
wherein one of the transfer network and the one transfer securement server is in communication with an account database comprising a first user account associated with the initiator, the first user account comprising an account balance,
determining, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; and
at a second point in time later than the first point in time, satisfying the precondition by transferring the collateral to the transfer securement administrator of the one transfer securement server.

2. A method according to claim 1, wherein the collateral increases by an increase amount between the first point in time and the second point in time, the increase amount being retained in the first user account upon transferral of the collateral.

3. A method for placing a precondition over collateral, the method comprising:
receiving, at a first point in time, initiation details of a transfer initiated by an initiator, the initiation details comprising a payment vehicle reference, transfer identifier and a transfer value;
sending the payment vehicle reference, transfer identifier and transfer value to a transfer network;
determining, based on the payment vehicle reference, one transfer securement server from a plurality of transfer securement servers each administered by a transfer securement administrator, the one transfer securement server being associated with the payment vehicle reference;
sending the payment vehicle reference, transfer identifier and transfer value to the one transfer securement server,
wherein one of the transfer network and the one transfer securement server is in communication with an account database comprising a first user account associated with the initiator, the first user account comprising an account balance,
determining, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value;
at a second point in time later than the first point in time, receiving from the initiator a transfer amount equivalent to the portion of the account balance; and
removing the precondition from the collateral.

4. A method according to claim 1, further comprising the step of locating multiple user accounts in the account database and associated with the initiator.

5. A method according to claim 4, wherein each user account is an account having a balance over which a precondition is authorised to be applied.

6. A method according to claim 4, wherein the first user account is identified as being one of the multiple user accounts and having a balance at least equal to the transfer value.

7. A method according to claim 4, wherein the determining step further comprises at least two user accounts of the multiple user accounts, one of the two user accounts being the first user account and each user account comprising a respective account balance, and determining if the transfer value exceeds a sum of the account balances of the at least two user accounts and, if not, placing a precondition to collateral comprising a portion of the sum, the portion being equal to at most the transfer value, if it is determined that the transfer value exceeds the account balance of the first user account.

8. A method according to claim 1, wherein the initiator is provided with a credit facility having a remaining credit limit, the method further comprising calculating a difference between the remaining limit and the transfer value, and setting the collateral as being equal to that difference.

9. A method according to claim 8, wherein, in the determining step, the account balance is sufficient to satisfy the transfer value if the account balance is at least equal to the collateral.

10. A method according to claim 8, further comprising the step of locating multiple user accounts in the account database and associated with the initiator.

11. A method according to claim 10, wherein each user account is an account having a balance over which a precondition is authorised to be applied.

12. A method according to claim 10, wherein the first user account is identified as being one of the multiple user accounts and having a balance at least equal to the collateral.

13. A method according to claim 10, wherein the determining step further comprises at least two user accounts of the multiple user accounts, one of the two user accounts being the first user account and each user account comprising a respective account balance, and determining if the collateral exceeds a sum of the account balances of the at least two user accounts and, if not, placing a precondition over a portion of the sum, the portion being equal to at most the transfer value, if it is determined that the transfer value exceeds the account balance of the first user account.

14. A system for placing a precondition over collateral, comprising a computer, the computer comprising:
at least one processor; and
at least one memory including computer program code;
the at least one memory and the computer program code configured to, with at least one processor, cause the computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; and
at a second point in time later than the first point in time, satisfy the precondition by transferring the collateral to the transfer securement administrator of the one transfer securement server.

15. A system as claimed in claim 14, wherein the collateral increases by an increase amount between the first point in time and the second point in time, the increase amount being retained in the first user account upon transferral of the collateral.

16. A system for placing a precondition over collateral, comprising a computer, the computer comprising:
at least one processor; and
at least one memory including computer program code;
the at least one memory and the computer program code configured to, with at least one processor, cause the computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value;
at a second point in time later than the first point in time, receiving from the initiator a transfer amount equivalent to the portion of the account balance; and
remove the precondition from the collateral.

17. A computer readable medium including computer program code for placing a precondition over collateral, the code being configured to, with at least one processor, cause a computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value; and
at a second point in time later than the first point in time, satisfy the precondition by transferring the collateral to the transfer securement administrator of the one transfer securement server.

18. A computer readable medium including computer program code for placing a precondition over collateral, the code being configured to, with at least one processor, cause a computer at least to:
receive, at a first point in time, initiation details of a transfer initiated by an initiator, the initiation details comprising a payment vehicle reference, transfer identifier and a transfer value;
send the payment vehicle reference, transfer identifier and transfer value to a transfer network;
determine, based on the payment vehicle reference, one transfer securement server from a plurality of transfer securement servers each administered by a transfer securement administrator, the one transfer securement server being associated with the payment vehicle reference;
send the payment vehicle reference, transfer identifier and transfer value to the one transfer securement server,
wherein one of the transfer network and the one transfer securement server is in communication with an account database comprising a first user account associated with the initiator, the first user account comprising an account balance,
determine, at the one of the transfer network and the one transfer securement server, based on the transfer value, whether the account balance is sufficient to satisfy the transfer value and, if so, allocating a precondition to collateral comprising a portion of the account balance, the portion being equal to at most the transfer value;
at a second point in time later than the first point in time, receiving from the initiator a transfer amount equivalent to the portion of the account balance; and
remove the precondition from the collateral.
